(19) United States
(12) Patent Application Publication
(10) Pub. No.: US 2007/0016934 A1
(43) Pub. Date: Jan. 18, 2007

(54) Broadcast receiving apparatus and server

(75) Inventors: Kazuo Okada, Koto-ku (JP); Jun Fujimoto, Koto-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/481,900

(22) Filed: Jul. 7, 2006

(30) Foreign Application Priority Data
Jul. 12, 2005 (JP) 2005-202774

(51) Int. Cl. H04N 7/173; H04N 5/44; H04N 7/18

(52) U.S. Cl. 725/100; 348/725; 725/81; 725/112; 725/113

(57) ABSTRACT

To provide a broadcast receiving apparatus which enables an enjoyment of a meticulous service when changing subscription contract details for a paid broadcast, even though a two-direction communication function is not furnished. A broadcast receiving apparatus includes: a broadcast receiver which receives limit broadcast data of a broadcast related to a program to a viewing of which a limit has been applied from a broadcasting station; a descrambler which enables the viewing of the program; and a transmitter which transmits code information, obtained by encoding limit release information for enabling the limit broadcast data received by the broadcast receiver to be made viewable by the descrambler, to a display.

### RELATED APPLICATION

This application claims the priority of Japanese Patent Application No. 2005-202774 filed on Jul. 12, 2005, which is incorporated herein by reference.

### BACKGROUND OF THE INVENTION

1. Technical Field

The present invention relates to a broadcast receiving apparatus and a server.

2. Related Art

Heretofore, in order that a paid broadcast transmitted via a satellite, a cable or the like can be viewed only by a specified recipient, a scramble has been applied to a television signal broadcast from a broadcasting station. By the recipient informing the broadcasting station by telephone etc. of his or her wish to release the scramble and view the broadcast, key information (a scrambling key) which releases the scramble is transmitted in coded form from the broadcasting station.

Individual key information (a master key) for decoding the key information is stored in a broadcast receiving apparatus installed in a home of each recipient, wherein the coded key information transmitted from the broadcasting station is decoded by the individual key information, thereby enabling the viewing of the broadcast (for example, Japanese Unexamined Patent Publication No. 7-154770).

In general, there are at least two kinds of charging methods for the paid broadcast. One is, for example, the charging method in which the recipient enters into a subscription contract with the broadcasting station which broadcasts the paid program, thereby becoming a member, and pays a fixed receiving fee (a so-called fixed amount charging method), while the other is the charging method in which a fee is set for each paid program, and paid as a lump sum after a fixed period (a so-called pay per view method).

With these kinds of contract formats, there has been a problem that the recipient, when wishing to view for a short period (for example, one month) with the fixed amount charging method, or whenever finding a program he or she wishes to watch with the pay per view method, has to telephone to inform the broadcasting station of the fact in order to enable the viewing. Also, with this kind of telephone procedure, there has been a problem that a reception time is restricted.

In recent years, therefore, a service has appeared in which the broadcast receiving apparatus is made able to carry out data communication via an internet with the broadcasting station etc. so that, when the broadcast recipient inputs the desired paid program etc. into the broadcast receiving apparatus, the viewing is enabled upon a setting of a charging in accordance with the program viewed, and the fee is paid as a lump sum after a certain fixed period has elapsed. With this kind of method, it is not necessary to carry out telephone procedures with the broadcasting station every time, and the procedure reception time is not restricted.

However, a problem has existed that in order to separately install a cable modem etc., for carrying out the data communication, it is necessary to secure an installation space. Also, with a broadcast receiving apparatus with a built-in cable modem, which has been conceived from the space-saving point of view, a recipient who does not use a two-direction communication function frequently has hesitated to purchase due to its high price in comparison with a non-built-in kind, which eventually causes a problem that it is not possible to receive the service described heretofore.

### SUMMARY OF THE INVENTION

Bearing in mind the problems described heretofore, the invention has been conceived with an aim of providing a broadcast receiving apparatus which enables an enjoyment of a meticulous service when changing subscription contract details for a paid broadcast, even though a two-direction communication function is not furnished.

In order to achieve the aim described heretofore, the invention provides the following.

A broadcast receiving apparatus comprising: a broadcast receiver which receives limit broadcast data of a broadcast related to a program to a viewing of which a limit has been applied from a broadcasting station; a descrambler which enables the viewing of the program; and a transmitter which transmits code information, obtained by encoding limit release information for enabling the limit broadcast data received by the broadcast receiver to be made viewable by the descrambler, to a display.

Also, the invention provides the following.

A server comprising: a limit release information receiver which receives limit release information from a user's portable terminal which generates the limit release information based on image data obtained by photographing code information, obtained by encoding the limit release information for releasing a limit of a program to a viewing of which the limit has been applied, with a photographic section furnished on the portable terminal; and a limit release signal transmitter which transmits a limit release signal which releases the limit of the program to the viewing of which the limit has been applied, based on the limit release information received by the limit release information receiver.

According to the invention, it is possible to provide a broadcast receiving apparatus and a server which enable an enjoyment of a meticulous service when changing subscription contract details for a paid broadcast, even though a two-direction communication function is not furnished.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

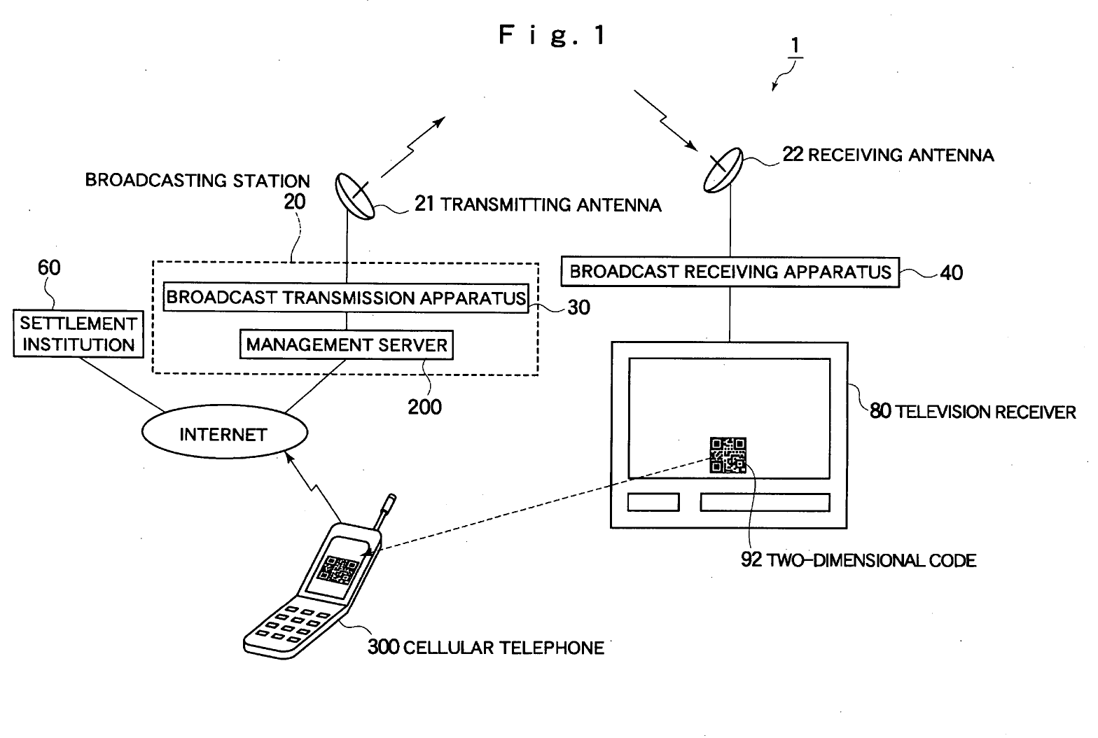

FIG. 1 is a configuration diagram showing an example of a broadcast transmission system according to an embodiment;

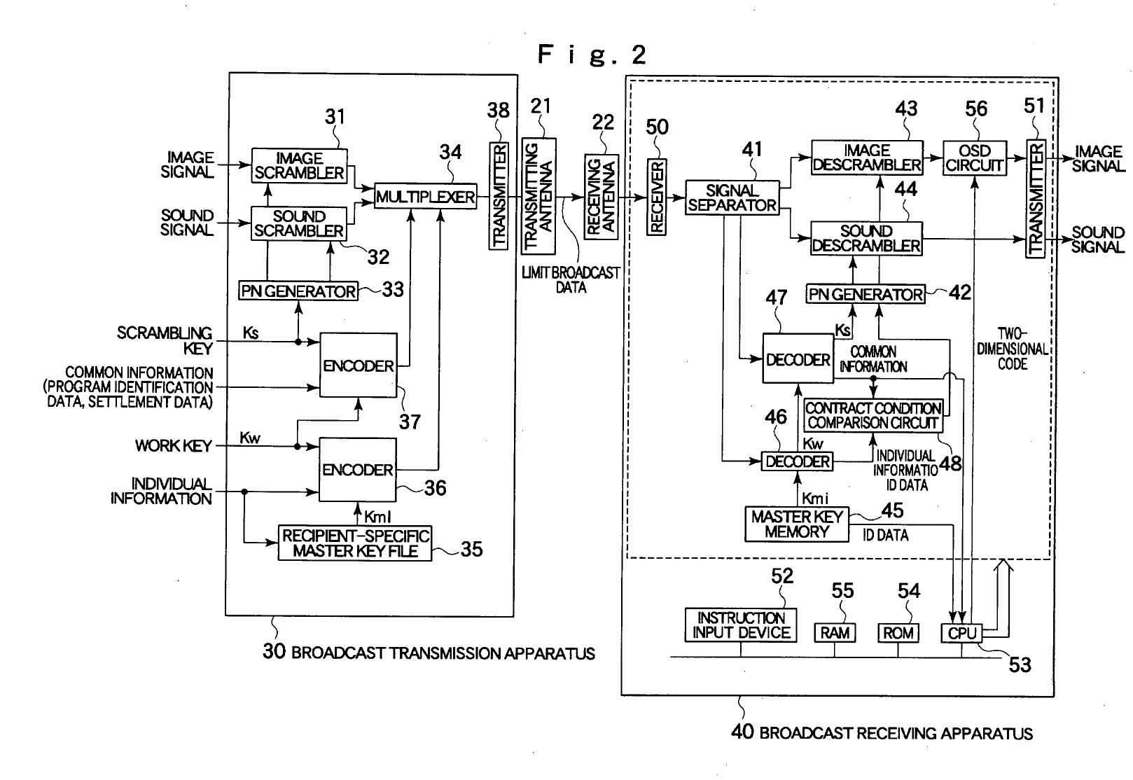

FIG. 2 is a block diagram showing an internal configuration of a broadcast transmission apparatus and a broadcast receiving apparatus shown in FIG. 1;

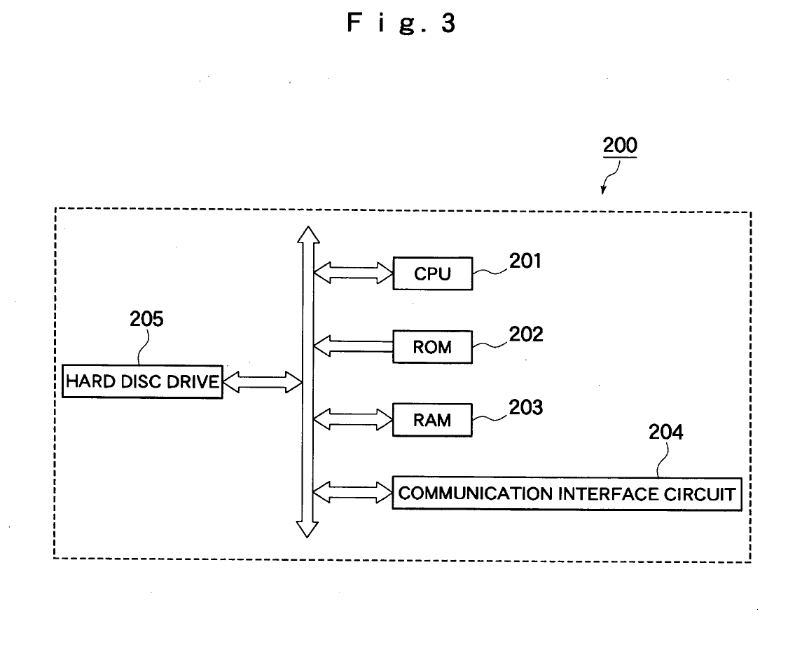

FIG. 3 is a block diagram showing an internal configuration of a management server shown in FIG. 1;

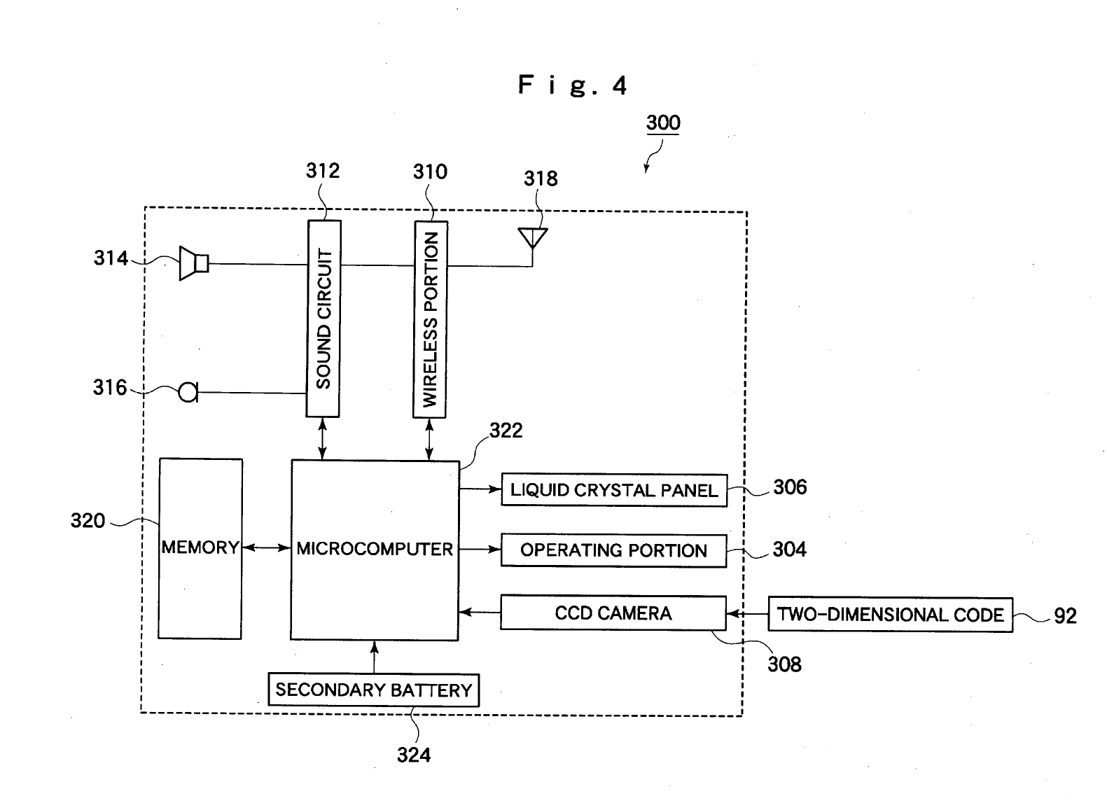

FIG. 4 is a block diagram showing an internal configuration of a cellular telephone shown in FIG. 1;

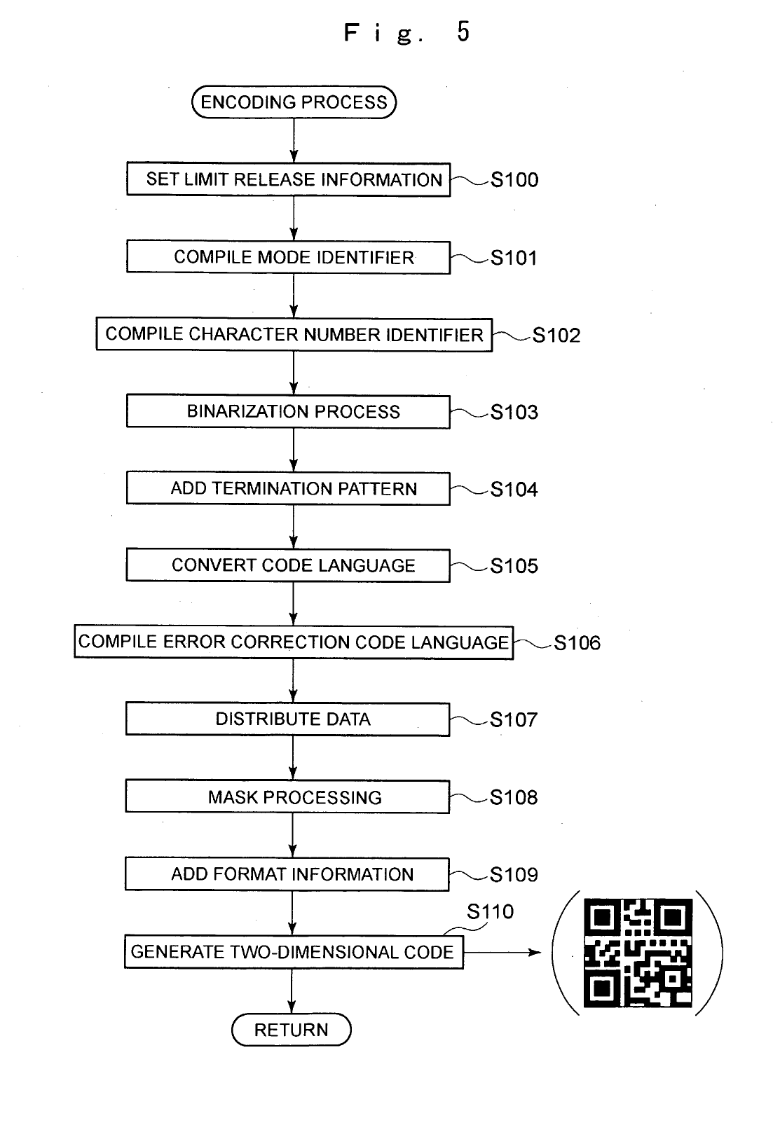

FIG. 5 is a flowchart showing a sub-routine of an encoding process executed in the broadcast receiving apparatus;

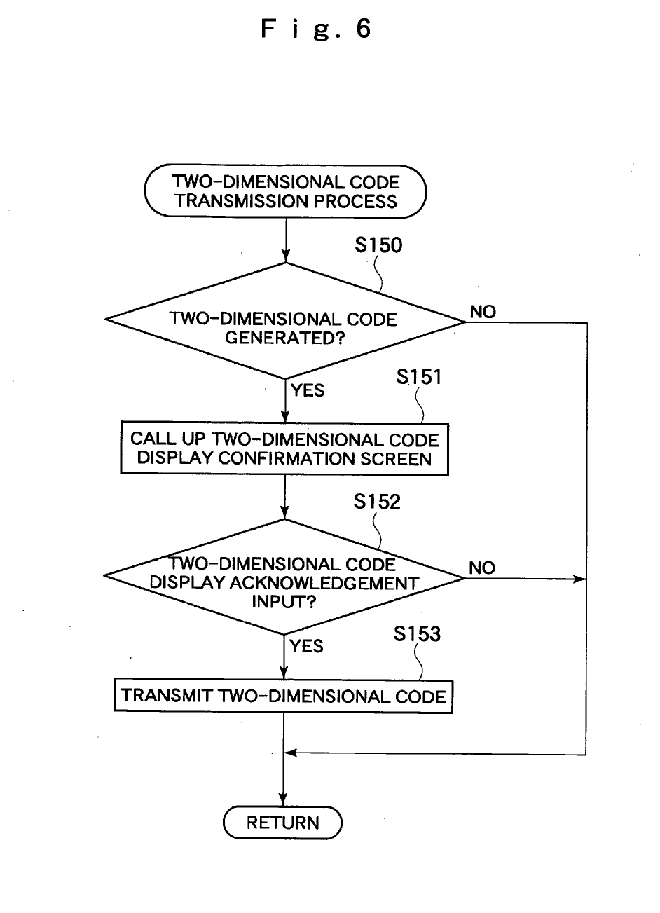

FIG. 6 is a flowchart showing a sub-routine of a two-dimensional code transmission process executed in the broadcast receiving apparatus;

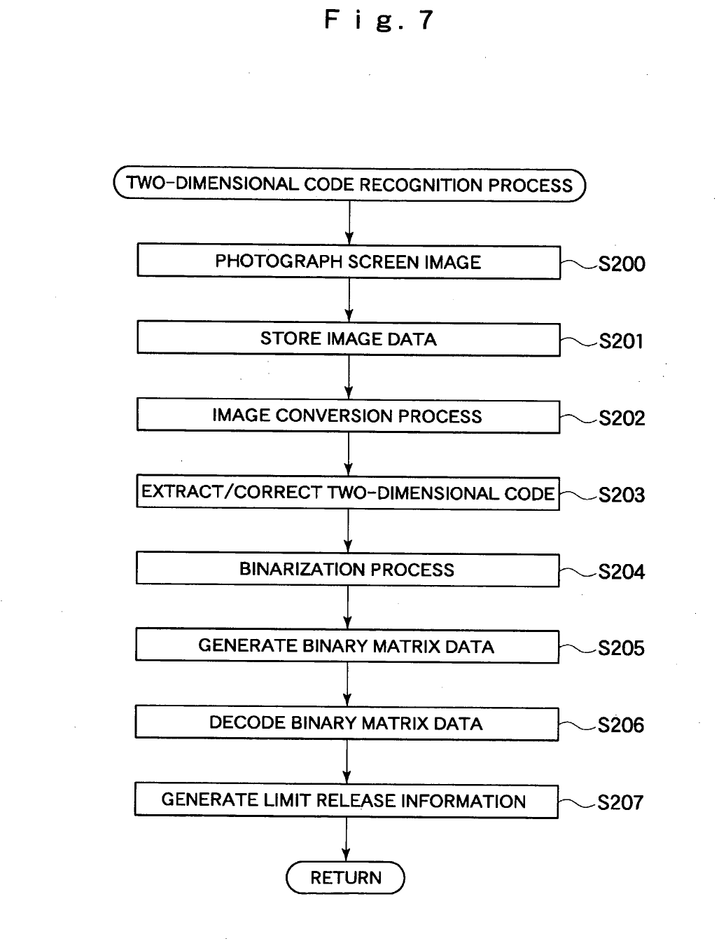

FIG. 7 is a flowchart showing a two-dimensional code recognition process executed in the cellular telephone; and

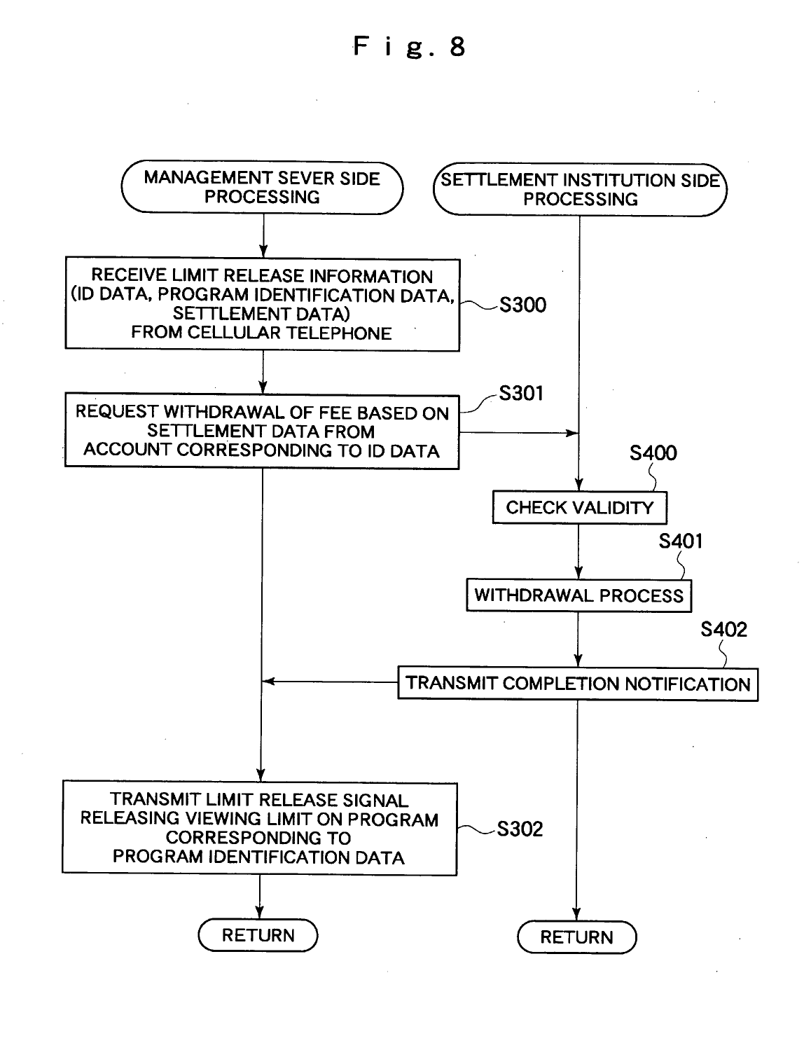

FIG. 8 is a flowchart showing a process executed in the management server and a settlement institution.

### DESCRIPTION OF THE PREFERRED EMBODIMENT(S)

A broadcast receiving apparatus according to an embodiment comprises: a broadcast receiver which receives limit broadcast data of a broadcast related to a program to a viewing of which a limit has been applied from a broadcasting station; a descrambler which enables the viewing of the program; and a transmitter which transmits code information, obtained by encoding limit release information for enabling the limit broadcast data received by the broadcast receiver to be made viewable by the descrambler, to a display.

According to such a configuration, the code information, which is obtained by encoding the limit release information for enabling the viewing of the program to the viewing of which the limit has been applied, is transmitted to the display (for example, a television receiver or a display device furnished on the broadcast receiving apparatus). Consequently, for example, when a recipient photographs the code information with a camera provided on a cellular telephone or the like, and transmits the limit release information generated based on the obtained image data to a server etc., a scrambling is released by the descrambler (scramble decoder) which decodes a scrambling signal, thereby enabling the viewing of the program to the viewing of which the limit has been applied. In this way, when changing the subscription contract details of a paid broadcast, even though an apparatus equipped with a two-direction communication function is not connected, it is not necessary to telephone the broadcasting station each time, and also, as there is no time restriction on the changing of the contract details, it is possible to enjoy a meticulous service.

Also, the broadcast receiving apparatus comprises: a memory storing ID data which identifies the broadcast receiving apparatus; a program identification data receiver which receives program identification data identifying the program to the viewing of which the limit has been applied from the broadcasting station; and a generator which generates code information obtained by encoding the limit release information, including the ID data stored in the memory and the program identification data received by the program identification data receiver, wherein the transmitter can transmit the code information generated by the generator to the display.

According to such a configuration, the code information is generated by encoding the limit release information including the ID data which identifies the broadcast receiving apparatus (for example, a set top box) and the program identification data received from the broadcasting station, and transmitted to the display (for example, the television receiver or the display device furnished on the broadcast receiving apparatus). In this way, as the limit release information includes the ID and the program identification data, for example, when the limit release information generated based on the code information photographed by the recipient is transmitted to the server etc., it becomes possible for the server to transmit a limit release signal, for releasing the viewing limit of the program, to the recipient of the ID data.

Also, the broadcast receiving apparatus comprises a settlement data receiver which receives settlement data used in a settlement of a viewing fee of the program to the viewing of which the limit has been applied from the broadcasting station, wherein the generator can also generate code information obtained by encoding the limit release information, including the settlement data received by the settlement data receiver.

According to such a configuration, as the settlement data used in the settlement of the viewing fee of the program to the viewing of which the limit has been applied is included in the limit release information, when the recipient photographs the code information with the camera or the like provided on the cellular telephone or the like, and transmits the limit release information generated based on the obtained image data to the server etc., it is possible to carry out the settlement of the viewing fee (for example, a fixed monthly receiving fee, a program viewing fee set for each program etc.).

Also, by printing or storing in a memory of a cellular telephone etc. the image data (for example, a bar code) obtained by photographing the code information, and having it read by a bar code reader or the like provided on a register of a convenience store, it becomes possible to carry out the settlement.

Also, in the embodiment, it is possible to provide a kind of server described hereafter.

A server comprising: a limit release information receiver which receives limit release information from a user's portable terminal which generates the limit release information based on image data obtained by photographing code information, obtained by encoding the limit release information for releasing a limit of a program to a viewing of which the limit has been applied, with a photographic section furnished on the portable terminal; and a limit release signal transmitter which transmits a limit release signal which releases the limit of the program to the viewing of which the limit has been applied, based on the limit release information received by the limit release information receiver.

According to such a configuration, when the limit release information generated by the portable terminal from the image data obtained by photographing the code information is received, based on the limit release information received, as the limit release signal which releases the viewing limit of the program to the viewing of which the limit has been applied is transmitted to the broadcast receiving apparatus etc. of the recipient, it becomes possible for the recipient to view the program to the viewing of which the limit has been applied. Consequently, when changing the subscription contract details of a paid broadcast, even though an apparatus equipped with a two-direction communication function is not connected, it is not necessary to telephone the broadcasting station each time, and also, as there is no time restriction on the changing of the contract details, it is possible to enjoy a meticulous service.

Also, in the server, the limit release information receiver can receive the limit release information, including ID data which identifies a broadcast receiving apparatus and program identification data which identifies the program to the viewing of which the limit has been applied, and the limit release signal transmitter can transmit the limit release signal for enabling the viewing of the program related to the received program identification data to the broadcast receiving apparatus corresponding to the received ID data.

According to such a configuration, when the limit release information, including the ID data which identifies the broadcast receiving apparatus (for example, the set top box) and the program identification data which identifies the program to the viewing of which the limit has been applied, is received, as the limit release signal for releasing the viewing limit of the program is transmitted to the broadcast receiving apparatus corresponding to the received ID data, it is possible to guarantee the enjoyment of a meticulous service.

Also, the server comprises a settlement process execution section which executes a process related to a settlement of a viewing fee, wherein the limit release information receiver can also receive the limit release information including the settlement data related to the settlement of the broadcast viewing fee, the settlement process execution section can also carry out the process related to the settlement of the viewing fee based on the settlement data included in the limit release information received by the limit release information receiver, and the limit release signal transmitter can also transmits the limit release signal after the settlement process execution section finishes the process related to the settlement of the viewing fee.

According to such a configuration, as the limit release signal is transmitted after the process related to the settlement is finished, the settlement is completed at that point. Consequently, as the receiver does not need to take effort to pay the viewing fee after viewing the program, it is extremely convenient.

Hereafter, a specific description of an embodiment of the invention will be given, based on the attached drawings.

FIG. 1 is a configuration diagram showing an example of a broadcast receiving system according to the embodiment.

A broadcast receiving system 1 comprises a broadcasting station 20, a broadcast receiving apparatus 40, which transmits broadcasting data received from the broadcasting station 20 to a television receiver 80, a cellular telephone 300 equipped with a CCD camera 308 (not shown, refer to FIG. 4) as a photographic section, and a settlement institution 60.

The broadcasting station 20 comprises a broadcast transmission apparatus 30 and the management server 200.

Common information including program identification, to be described hereafter, and the settlement data, and individual information such as the receiver's ID data, is stored in the management server 200. The broadcast transmission apparatus 30 multiplexes the common information and individual information supplied from the management server 200, and transmits it from a transmitting antenna 21 along with a scrambled image signal and sound signal as limit broadcasting data.

The broadcast receiving apparatus 40, on receiving the limit broadcasting data from a receiving antenna 22, separates the signal to extract the image signal, sound signal, common information and individual information. Then, it is determined from the received common information, individual information and a master key stored in the broadcast receiving apparatus 40 whether or not the recipient has made a subscription contract for the program wherein, in the event that it is determined that the subscription contract has been made, the scramble is released and the viewing becomes possible.

Furthermore, the broadcast receiving apparatus 40 generates a two-dimensional code by encoding the limit release information, including the received program identification data and settlement data, and the ID data stored in the broadcast receiving apparatus 40, and transmits it to the television receiver 80 superimposed with the image signal. The limit release information is the information for releasing the limit of the program to the viewing of which the limit is applied.

When a two-dimensional code 92 is displayed on the television receiver 80, which acts as the display, the recipient can photograph the two-dimensional code 92 with the CCD camera 308 provided on the cellular telephone 300.

The cellular telephone 300 recognizes a two-dimensional code from the image data obtained when the CCD camera 308 photographs the two-dimensional code 92, and generates the limit release information from the recognized two-dimensional code. Then, it transmits the limit release information to the management server 200.

The management server 200, on receiving the limit release information from the cellular telephone 300, requests the settlement institution 60 to carry out a settlement and, when the settlement is completed, transmits a limit release signal, which releases the viewing limit, to the broadcast transmission apparatus 30.

In this way, according to the broadcast transmission system 1, the recipient, by photographing the two-dimensional code 92 displayed on a screen of the television receiver 80 with the CCD camera 308 provided on the cellular telephone 300, can obtain the limit release information and, by transmitting the limit release information to the management server 200, can release the limit for the program for which the viewing has a limit applied. Also, the settlement of the program viewing fee can be carried out.

In the embodiment, a description is given of a case in which the two-dimensional code is used as the code information, but the code information in the invention includes not only the two-dimensional code, but also a one-dimensional code (a bar code). Also, in the embodiment, a description is given of a case in which a QR code (a registered trademark) is used as the two-dimensional code, but the invention is not limited to this example.

The cellular telephone 300 corresponds to the portable terminal in the invention. The portable terminal in the invention, as long as it is equipped with a photographic section and can carry out a transmission and reception of data via the management server and a communication line, is not particularly limited and can include, for example, a personal digital assistant.

Also, in the embodiment, a description is given of a case in which the cellular telephone 300 and the management server 200 carry out the transmission and reception of the data wirelessly, but the invention is not limited to this example as it is also acceptable to carry out the transmission and reception by wire. That is, the transmission line in the invention includes both a wired and a wireless transmission path.

FIG. 2 is a block diagram showing an internal configuration of the broadcast transmission apparatus and the broadcast receiving apparatus shown in FIG. 1.

As shown in FIG. 2, the broadcast transmission apparatus 30 comprises an image scrambler 31, a sound scrambler 32, a PN generator 33, a multiplexer 34, a recipient-specific master key file 35, encoders 36 and 37, and a transmitter 38. Each portion is controlled by a not-shown CPU in accordance with a prescribed program stored in a ROM etc.

First, in the broadcast transmission apparatus 30, when the image signal and sound signal to be broadcast are input into a corresponding image scrambler 31 and sound scrambler 32, a scrambling process is carried out in accordance with a PN series supplied from the PN generator 33, based on an initial value prescribed by a scramble key Ks.

The PN generator 33 has a circuit which generates a pseudo code series (PN series) based on a prescribed regulation, wherein the initial value is set by the scramble key Ks. The scramble key Ks, being that which sets the initial value of the PN series used in the image scrambler 31 and the sound scrambler 32, is used for a synchronization with a PN generator 42 furnished on the broadcast receiving apparatus 40. A previously known technology (for example, regarding the image signal, a scan in line signal switch method or a scan line transfer method and, regarding the sound signal, a PN signal series addition method etc.) can be employed for the scrambling process.

In the encoder 37, the scramble key Ks is encoded along with the common information such as the program identification data and the settlement data but, at this time, a work key Kw is input into the encoder 37 as an encoding key when the scramble key Ks is transferred, and encoded along with it. The work key Kw is used as the encoding key when the scramble key Ks is transferred. The program identification data refers to the data which identifies the program, and includes for example, a program name, a program code etc. The settlement data refers to the data used in the settlement of the viewing fee of the program, and includes an address (a URL) for the settlement inside the management server 200 and specific viewing fee data. In the broadcast transmission apparatus 30, the common information is transmitted from the management server 200 at a prescribed timing, and encoded by the encoder 37.

However, when the individual information such as the subscription details and the ID data of the broadcast receiving apparatus 40 are input into the recipient-specific master key file 35, and a master key Kmi differing for each recipient (each broadcast receiving apparatus 40) is read off, the master key Kmi is input into the encoder 36 as the encoding key, wherein the work key Kw is encoded along with the individual information. The master key file 35 stores a multiple of master keys Kml to Kmn, one of which, a master key Kmx, is selected according to a selection command from the management server 200. The ID data, being the data which identifies the broadcast receiving apparatus 40, is the data unique to the broadcast receiving apparatus 40. In the broadcast transmission apparatus 30, the individual information is received from the management server 200 at a prescribed timing, and encoded in the encoder 36.

Then, each of the output signals transmitted from the image scrambler 31, the sound scrambler 32 and the encoders 36 and 37, after being input into the multiplexer 34 to be multiplexed, is transmitted to each recipient as the limit broadcast data from the transmitting antenna 21 via the transmitter 38.

Also, the broadcast receiving apparatus 40 comprises a signal separator 41, a PN generator 42, an image descrambler 43, a sound descrambler 44, a master key memory 45, decoders 46 and 47, a subscription condition comparison circuit 48, a receiver 50 acting as the broadcast receiver, a transmitter 51 acting as the transmitter, an instruction input device 52, a CPU 53, a ROM 54, and a RAM 55.

In the broadcast receiving apparatus 40, when the limit broadcast data is received from the receiving antenna 22 via the receiver 50, each multiplexed signal is separated by the signal separator 41. In this way, the scrambled image signal is input into the image descrambler 43, the scrambled sound signal is input into the sound descrambler 44, the code signal encoded by the encoder 36 is input into the decoder 46, and the code signal encoded by the encoder 37 is input into the decoder 47. The limit broadcast data includes the program identification data and the settlement data. The receiver 50, as well as functioning as the program identification data receiver, also functions as the settlement data receiver.

The master key memory 45, being an IC chip installed non-removably inside the broadcast receiving apparatus 40, stores the master key Kmi and ID data unique to the broadcast receiving apparatus 40. The master key memory 45 functions as the memory storing the ID data which identifies the broadcast receiving apparatus 40. In the decoder 46, the work key Km and the individual information in the scrambled broadcast signal received are decoded using the master key Kmi. The decoded work key Kw is input into the decoder 47 as the decoding key. In the decoder 47, the scrambling key Ks and the common information in the scrambled broadcast signal received are each decoded.

The individual information extracted from the decoder 46 and the common information extracted from the decoder 47 are each input into the subscription condition comparison circuit 48, where it is determined whether or not prescribed subscription conditions are satisfied. In the event that the subscription conditions are satisfied, an operation signal is transmitted from the subscription condition comparison circuit 48 to the PN generator 42. When the operation signal is input, and a correct scrambling key Ks is input from the decoder 47, the PN generator 42 generates the same PN series as the PN series transmitted from the PN generator 33 of the broadcast transmission apparatus 30, and inputs it into each of the image descrambler 43 and the sound descrambler 44. By this means, the image signal for which the scrambling process has been released is extracted from the image descrambler 43, and the sound signal for which the scrambling process has been released is extracted from the sound descrambler 44.

Also, the CPU 53 generates a two-dimensional code by encoding the limit release information, including the ID data stored in the master key memory 45 and the common information (the program identification data and the settlement data) extracted from the decoder 47. The two-dimensional code is transmitted to an OSD (on screen display) circuit 56, where it is synthesized with the image signal transmitted from the image descrambler 43, and transmitted from the transmitter 51. Also, the sound signal transmitted from the sound descrambler 44 is transmitted from the transmitter 51.

The instruction input device 52 is for carrying out the instruction input related to the broadcast reception, such as the switching of the channel and the display of the two-dimensional code. When the two-dimensional code is generated, a two-dimensional code display confirmation screen is displayed, whereby it becomes possible to select the program related to the two-dimensional code. When the recipient selects the program he or she wishes to view from among the programs which have become selectable, the two-dimensional code is transmitted.

The ROM 54 stores the prescribed program for operating the broadcast receiving apparatus 40, control commands for giving instructions to each portion, etc. The RAM 55, as a temporary memory area of the CPU 53, has a function which stores various variables, the generated two-dimensional codes etc.

FIG. 3 is a block diagram showing an internal configuration of the management server of the broadcasting station.

The management server 200 comprises a CPU 201 as a calculation processing device, a ROM 202, a RAM 203, a communication interface circuit 204, and a hard disc drive 205.

The communication interface circuit 204, being capable of communicating with the cellular telephone 300 and the settlement institution 60 via an internet, is also, being connected to the broadcast transmission apparatus 30, capable of carrying out the data transmission.

The data such as the program identification data and the settlement data is stored in the hard disc drive 205 as common information. The common information is transmitted to the broadcast receiving apparatus 40, via the communication interface circuit 204, at the prescribed timing, in accordance with the details of the program transmitted from the broadcast receiving apparatus 40.

Also, the subscription details of the recipient, the ID data of the broadcast receiving apparatus 40, an account number and a personal name of the settlement institution 60 used by the recipient etc., are stored as the individual information in the hard disc drive 205. From the individual information, prescribed information such as the subscription details of the recipient and the ID data, is transmitted to the broadcast receiving apparatus 40, at a prescribed timing, in accordance with the details of the program broadcast.

Also, the hard disc drive 205 has an area which correlates and stores the broadcast receiving apparatus 40 ID data, the program identification data and the settlement data received from the cellular telephone 300. The CPU 201, on receiving the ID data, the program identification data and the settlement data from the cellular telephone 300, reads off the account number etc. of the recipient corresponding to the ID data, and carries out a request to the settlement institution 60 to withdraw the viewing fee based on the settlement data from the account. In the embodiment, a description is given of a case in which the settlement is carried out based on the account number of the recipient corresponding to the ID data but, without limiting it to this example, it is also acceptable that it is a number of a credit card etc., because as long as it is possible to carry out the settlement, it is not particularly limited.

Furthermore, the CPU 201, on receiving a withdrawal completion notification from the settlement institution 60, includes the limit release signal (the ID data), which releases the viewing limit of the program corresponding to the program identification data, in the individual information, and transmits it to the broadcast transmission apparatus 30 at the prescribed timing (for example, the timing of the start of the broadcast of the program). As a result, it becomes possible to view the program only on the broadcast receiving apparatus 40 of the recipient corresponding to the limit release signal (the ID data).

In the embodiment, a description is given of a case in which the limit release signal is the ID data, but the limit release signal in the invention is not limited to this example, as it is acceptable to include other data, or not to include the ID data, it being sufficient that it is the data for releasing the viewing limit only in the broadcast receiving apparatus 40 corresponding to the ID data.

Also, the hard disc drive 205 stores a program for the purpose of downloading into the cellular telephone 300. The CPU 201, when receiving a signal from the cellular telephone 300 requesting a download of the program, reads off the program from the hard disc drive 205, and transmits the program from the communication interface circuit 204, via the internet, to the cellular telephone 300.

FIG. 4 is a block diagram showing an internal configuration of the cellular telephone shown in FIG. 1.

The cellular telephone 300 comprises an operating portion 304, a liquid crystal panel 306, a CCD camera 308 as the photographic section, a wireless portion 310, a sound circuit 312, a speaker 314, a microphone 316, a transmitting/receiving antenna 318, a non-volatile memory 320, a microcomputer 322 and a secondary battery 324.

The wireless portion 310, being controlled by the microcomputer 322, transmits and receives electric waves as a medium through the transmitting/receiving antenna 318 with respect to a base station. The sound circuit 312, as well as transmitting the received signal transmitted through the microcomputer 322 from the wireless portion 310 to the speaker 314, transmits the sound signal transmitted from the microphone 316 through the microcomputer 322, as a transmission signal, to the wireless portion 310.

The speaker 314 converts the received signal transmitted from the sound circuit 312 into a received sound and transmits it, while the microphone 316 converts a transmission sound generated by an operator into a sound signal and transmits it to the sound circuit 312.

The CCD camera 308 is capable of photographing the two-dimensional code 92 displayed on the screen of the television receiver 80, wherein the image data obtained by the photographing is stored in the non-volatile memory 320. In the embodiment, although a description is given of a case in which the CCD camera is used as the photographic section, the photographic section in the invention is not particularly limited and can include, for example, a CMOS sensor camera etc.

The non-volatile memory 320 non-volatilely stores various data such as, for example, the image data obtained by the CCD camera 308 photographing the two-dimensional code 92, and various programs.

The secondary battery 324 supplies energy to each circuit. The microcomputer 322, comprising a CPU, a ROM and a RAM, carries out, for example, a telephone calling and receiving process, an electronic mail compilation, transmitting and receiving process, an internet process and the like. The microcomputer 322 carries out the transmission and receiving of the electronic mail, and the transmission and receiving of the data by the internet, via the wireless portion 310 and the transmitting/receiving antenna 318.

The microcomputer 322, based on a prescribed instruction input via the operating portion 304, downloads the prescribed program from the server 200 via the internet, and stores it in the non-volatile memory 320. Then, the microcomputer 322, by reading off the program from the non-volatile memory 320 and executing it, functions as in A and B described hereafter.

A. The microcomputer 322 recognizes the two-dimensional code from the image data obtained when the CCD camera 308 photographs the two-dimensional code 92, and generates the limit release information from the recognized two-dimensional code.

B. The microcomputer 322 transmits the limit release information generated in A above, via the internet, to the server 200 by means of the wireless portion 310 and the transmitting/receiving antenna 318.

In the embodiment, although a description is given of a case in which the cellular telephone 300 downloads the program from the server 200, it is also acceptable to have it stored in the non-volatile memory 320 of the cellular telephone 300 in advance (pre-installed).

FIG. 5 is a flowchart showing an encoding process executed in the broadcast receiving apparatus. This process is executed when the common information (the program identification data and the settlement data) is decoded by the decoder 47. First, the common information (the program identification data and the settlement data) decoded by the decoder 47, and the ID data stored in the master key memory 45, is set (step S100).

Next, a mode identifier is compiled in accordance with a character type (for example, a number, an alpha-numeral etc.) of the limit release information (step S101). Next, a character number identifier is compiled in accordance with a number of characters of the limit release information (step S102). Next, a binarization processing of the limit release information is carried out (step S103). Next, a process is carried out whereby a termination pattern is added to data obtained from steps S101 to S103 (step S104).

Next, a code language conversion for the data obtained in step S104 is carried out (step S105), furthermore, an error correction code language is compiled based on the data obtained from step S105, and added to the data obtained from step S105 (step S106). Next, a process is carried out wherein the data obtained from step S106 is binarized, and disposed in a matrix form (step S107).

Next, a process is carried out wherein a mask of a prescribed pattern is applied to the data obtained from step S107 (step S108). Next, a process is carried out wherein format information including an error correction level and a mask identifier is added (step S109), and the two-dimensional code is generated (step S110). The generated two-dimensional code is stored in the RAM 55. After that, this sub-routine is completed. In the steps S100 to S110, the broadcast receiving apparatus 40 functions as the generator which generates the two-dimensional code.

In the embodiment, although a description is given of a case in which the ID data, the program identification data and the settlement data, as limit release information, are encoded into the two-dimensional code, the invention is not limited to this, as it is also acceptable to include, for example, broadcasting station distinguishing data, which distinguishes the broadcasting station, and the like.

Also, in the embodiment, a description is given of a case in which only the limit release information is encoded into the two-dimensional code but, in the invention, it is also acceptable to encode the limit release information and other data.

FIG. 6 is a flowchart showing the sub-routine of the two-dimensional code transmission process executed in the broadcast receiving apparatus. This sub-routine, unlike the process shown in FIG. 5, is called up and executed at a prescribed timing from a previously executed main routine.

First, it is determined whether or not the two-dimensional code has been generated (step S150) and, if it is determined that it has not been generated, the sub-routine is completed.

Conversely, if it is determined that it has been generated, the two-dimensional code display confirmation screen is called up in order to confirm whether or not the two-dimensional code is to be displayed (step S151). At this time, if a plurality of two-dimensional codes has been generated, the two-dimensional code display confirmation screen is called up after receiving a selection of the two-dimensional code.

Next, it is determined whether or not there has been a two-dimensional code display acknowledgement input (step S152). If there has been a two-dimensional code display acknowledgement input from the recipient via the instruction input device 52, the two-dimensional code stored in the RAM 55 is called up and transmitted (step S153), whereon the sub-routine is completed. Conversely, if there has not been a two-dimensional code display acknowledgement input, the sub-routine is completed.

FIG. 7 is a flowchart showing a two-dimensional code recognition process executed in the cellular telephone.

First, the microcomputer 322 furnished on the cellular telephone 300, based on the instruction input via the operating portion 304, drives the CCD camera 308 which acts as the photographic section, thereby photographing the two-dimensional code 92 displayed on the screen of the television receiver 80 (step S200).

Next, the microcomputer 322 stores the image data obtained from step S200 in the non-volatile memory 320 (step S201).

Next, the microcomputer 322 carries out an image conversion process for the image data stored in the non-volatile memory 320 (step S202). The image conversion process is a process which picks out the image data of the area in which the two-dimensional code is displayed from the image data obtained by photographing, corrects any tilting or distortion, and converts it to a black and white image according to a prescribed threshold, thereby obtaining the image data including the two-dimensional code seen from the front.

Next, the microcomputer 322 extracts the two-dimensional code from the image data obtained from step S202, and carries out the corrections such as a noise removal (step S203).

Next, the microcomputer 322 carries out the binarization processing of the two-dimensional code obtained from step S203, replaces each dot forming the two-dimensional code with a 0 or a 1 (step S204), and generates binary matrix data (step S205). Next, the microcomputer 322 decodes the binary matrix data (step S206), and generates the limit release information (step S207). After that, the sub-routine is completed.

FIG. 8 is a flowchart showing a process executed in the management server and the settlement institution. First, the management server 200 receives limit release information obtained from the two-dimensional code recognition process from the cellular telephone 300 via the internet (step S300). At this time, the management server 200 functions as a limit release information receiver which receives the limit release information from the cellular telephone 300.

Next, the management server 200 reads off the account number and personal name of the recipient corresponding to the ID data included in the limit release information, and carries out a request to the settlement institution 60 to withdraw the viewing fee based on the settlement data from the account (step S301). At this time, the management server 200 functions as a settlement processor which carries out the process related to the settlement of the viewing fee.

The settlement institution 60, after checking a validity of the request for withdrawal (step S400), such as a compliance etc. of the account number and the personal name, executes the withdrawal process (step 401), and transmits the withdrawal completion notification to the management server 200 (step S402). The settlement institution 60 may include a bank, a credit card company or the like.

The management server 200, on receiving the withdrawal completion notification, transmits the limit release signal, which releases the viewing limit of the program corresponding to the program identification data included in the limit release information received in step S300, to the broadcast transmission apparatus 30 at the prescribed timing (for example, the timing of the start of the broadcast of the program) (step S302). At this time, the management server 200 functions as a limit release signal transmitter which transmits the limit release signal. As a result, it becomes possible for the recipient to view the program to the viewing of which the limit has been applied.

As described heretofore, according to the broadcast receiving apparatus 40 in the embodiment, the two-dimensional code 92 obtained by encoding the limit release information is transmitted to the television receiver 80. Consequently, the recipient, by photographing the two-dimensional code 92 with the CCD camera 308 provided on the cellular telephone 300, and transmitting the limit release information generated based on the obtained image data to the management server 200, can view the program to the viewing of which the limit has been applied. In this way, when changing the subscription contract details of the paid broadcast, even though an apparatus equipped with a two-direction communication function is not connected, it is not necessary to telephone etc. the broadcasting station 20 each time, and, as there is no time restriction on the changing of the contract details, it is possible to enjoy a meticulous service.

Also, according to the broadcast receiving apparatus 40, the two-dimensional code 92 is generated by encoding the limit release information, including the ID data which identifies the broadcast receiving apparatus 40 and the program identification data received from the broadcasting station 20, and transmitted to the television receiver 80. In this way, as the ID data and the program identification data are included in the limit release information, for example, when the limit release information generated based on the two-dimensional code 92 photographed by the recipient is transmitted to the management server 200, the management server 200 is enabled to transmit the limit release signal for releasing the viewing limit of the program to the recipient of the ID data.

Also, according to the broadcast receiving apparatus 40, as the settlement data is included in the limit release information, the recipient, by photographing the two-dimensional code 92 with the CCD camera 308 provided on the cellular telephone 300, and transmitting the limit release information generated based on the obtained image data to the management server 200, can carry out the settlement of the viewing fee (for example, the fixed monthly receiving fee, the program viewing fee set for each program etc.).

Also, according to the management server 200 in the embodiment, as on receiving the limit release information generated by the cellular telephone 300 from the image data obtained by photographing the two-dimensional code 92, based on the received limit release information, the limit release signal for releasing the limit of the program to the viewing of which the limit has been applied is transmitted to the broadcast receiving apparatus 40 of the recipient, it becomes possible for the recipient to view the program to the viewing of which the limit has been applied. Consequently, when changing the subscription contract details of the paid broadcast, even though the apparatus equipped with the two-direction communication function is not connected, it is not necessary to telephone etc. the broadcasting station 20 each time, and, as there is no time restriction on the changing of the contract details, it is possible to enjoy a meticulous service.

Also, according to the management server 200, as when the limit release information, including the ID data which identifies the broadcast receiving apparatus 40 and the program identification data which identifies the program to the viewing of which the limit has been applied, is received, the limit release signal for releasing the viewing limit of the program is transmitted to the broadcast receiving apparatus 40 corresponding to the received ID data, it is possible to guarantee the enjoyment of a meticulous service.

Also, according to the management server 200, as the limit release signal is transmitted after the process related to the settlement is finished, the settlement is completed at that point. Consequently, as the recipient does not need to go to the trouble of paying the viewing fee after viewing the program, it is extremely convenient.

Although, in the embodiment, a description is given of a case in which the two-dimensional code is transmitted to the television receiver 80, the display in the invention is not limited to this example. It is also acceptable that it is a display, a projector or the like, furnished on a personal computer.

Also, in the embodiment, a description is given of a case in which the two-dimensional code is transmitted to the television receiver 80 connected to the exterior of the broadcast receiving apparatus 40, but the invention is not limited to this. For example, it is also acceptable that the broadcast receiving apparatus 40 is configured to include a display, by building the broadcast receiving apparatus 40 into the television receiver 80 and the like.

Although, in the embodiment, a description is given of a case in which the memory is the IC chip installed non-removably inside the broadcast receiving apparatus 40, it is also acceptable that it is the ROM, the hard disc or the like.

Also, in the embodiment, a description is given of a case in which the IC chip stores the ID data, but it is also acceptable to provide an IC chip reader instead of the IC chip, and store the data on a card with a built-in IC chip etc. inserted from the exterior.

In the embodiment, a description is given of a case in which the management server 200 and the broadcast transmission apparatus 30 are provided individually, but it is also acceptable in the invention that the management server 200 includes the broadcast transmission apparatus 30.

Although, in the embodiment, a description is given of a case in which, when the limit release information is transmitted to the management server 200, the viewing of the program to which the limit has been applied becomes possible after the settlement is carried out, in the invention, it is also acceptable to input etc. a password before carrying out the settlement.

Although, in the embodiment, a description is given of a case in which the program identification data is transmitted from the broadcasting station 20, the invention is not limited to this. It is also acceptable, for example, that it is input from the instruction input device 52.

Although, in the embodiment, a description is given of a case in which the management server 200 transmits the limit release signal to the broadcast transmission apparatus 30 on condition that the settlement is completed, it is acceptable in the invention that the limit release signal is transmitted even though the settlement is not completed. In this case, by printing or storing in the memory of the cellular telephone 300 etc. the image data obtained by photographing the two-dimensional code 92, and having it read by the bar code reader or the like furnished on the register of the convenience store, it becomes possible to carry out the settlement.

Heretofore, a description has been given of the embodiment of the invention, but this has only illustrated a specific example, and in no way limits the scope of the invention. The design of the specific configuration of each of the sections etc. can be changed as appropriate. Also, the advantageous effects mentioned in the embodiment of the invention are merely examples of the most suitable advantageous effects arising from the invention, and the advantageous effects of the invention are not limited to those mentioned in the embodiment of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcast receiving apparatus comprising:
a broadcast receiver which receives limit broadcast data of a broadcast related to a program to a viewing of which a limit has been applied, from a broadcasting station;
a descrambler which enables the viewing of the program; and
a transmitter which transmits code information, obtained by encoding limit release information for enabling the limit broadcast data received by the broadcast receiver to be made viewable by the descrambler, to a display.

2. A broadcast receiving apparatus according to claim 1, comprising:
a memory storing ID data which identifies the broadcast receiving apparatus;
a program identification data receiver which receives program identification data identifying the program to the viewing of which the limit has been applied, from the broadcasting station; and
a generator which generates code information obtained by encoding the limit release information, including the ID data stored in the memory and the program identification data received by the program identification data receiver, wherein
the transmitter transmits the code information generated by the generator to the display.

3. A broadcast receiving apparatus according to claim 2, comprising
a settlement data receiver which receives settlement data used in a settlement of a viewing fee of the program to the viewing of which the limit has been applied, from the broadcasting station, wherein
the generator generates code information obtained by encoding the limit release information, including the settlement data received by the settlement data receiver.

4. A server comprising:
a limit release information receiver which receives limit release information from a user's portable terminal which generates the limit release information based on image data obtained by photographing code information, obtained by encoding the limit release information for releasing a limit of a program to a viewing of which the limit has been applied, with a photographic section furnished on the portable terminal; and
a limit release signal transmitter which transmits a limit release signal which releases the limit of the program to the viewing of which the limit has been applied, based on the limit release information received by the limit release information receiver.

5. A server according to claim 4, wherein
the limit release information receiver receives the limit release information, including ID data which identifies a broadcast receiving apparatus and program identification data which identifies the program to the viewing of which the limit has been applied, and
the limit release signal transmitter transmits the limit release signal for enabling the viewing of the program related to the received program identification data to the broadcast receiving apparatus corresponding to the received ID data.

6. A server according to claim 5, comprising
a settlement process execution section which executes a process related to a settlement of a viewing fee, wherein
the limit release information receiver receives the limit release information including settlement data related to the settlement of the broadcast viewing fee,
the settlement process execution section carries out the process related to the settlement of the viewing fee based on the settlement data included in the limit release information received by the limit release information receiver, and
the limit release signal transmitter transmits the limit release signal after the settlement process execution section finishes the process related to the settlement of the viewing fee.
